(19) United States
(12) Patent Application Publication
(10) Pub. No.: US 2018/0082436 A1
(43) Pub. Date: Mar. 22, 2018

(54) IMAGE PROCESSING APPARATUS, IMAGE PROCESSING SYSTEM, AND IMAGE PROCESSING METHOD

(71) Applicant: MITSUBISHI ELECTRIC CORPORATION, Tokyo (JP)

(72) Inventors: Ryoji HATTORI, Tokyo (JP); Yoshimi MORIYA, Tokyo (JP); Kazuyuki MIYAZAWA, Tokyo (JP); Akira MINEZAWA, Tokyo (JP); Shunichi SEKIGUCHI, Tokyo (JP)

(73) Assignee: MITSUBISHI ELECTRIC CORPORATION, Tokyo (JP)

(21) Appl. No.: 15/565,659

(22) PCT Filed: Sep. 15, 2015
(86) PCT No.: PCT/JP2015/076161

§ 371 Date: Oct. 10, 2017

(51) Int. Cl. G06T 7/70; G06T 11/60; G06F 3/14; G06T 1/60

(52) U.S. Cl. CPC G06T 7/70; G06T 11/60; G06T 2207/30242; G06T 1/60; G06T 2207/10016; G06F 3/14

(57) ABSTRACT

An image processing apparatus (10) includes an image analyzer (12) that analyzes an input image to detect one or more objects appearing in the input image, and estimates quantities of one or more spatial features of the detected one or more objects; and a descriptor generator (13) that generates one or more spatial descriptors representing the estimated quantities of the one or more spatial features.

### TECHNICAL FIELD

The present invention relates to an image processing technique for generating or using descriptors representing the content of image data.

### BACKGROUND ART

In recent years, with the spread of imaging devices that capture images (including still images and moving images), the development of communication networks such as the Internet, and the widening of the bandwidth of communication lines, the spread of image delivery services and an increase in the scale of the image delivery services have taken place. With such circumstances as a background, in services and products targeted at individuals and business operators, the number of pieces of image content accessible by users is enormous. In such a situation, in order for a user to access image content, techniques for searching for image content are indispensable. As one search technique of this kind, there is a method in which a search query is an image itself and matching between the image and search target images is performed. The search query is information inputted to a search system by the user. This method, however, has the problem that the processing load on the search system may become very large, and when the quantity of transmit data upon transmitting a search query image and search target images to the search system is large, the load placed on a communication network becomes large.

To avoid the above problem, there is a technique in which visual descriptors in which the content of an image is described are added to or associated with the image, and used as search targets. In this technique, descriptors are generated in advance based on the results of analysis of the content of an image, and data of the descriptors can be transmitted or stored separately from the main body of the image. By using this technique, the search system can perform a search process by performing matching between descriptors added to a search query image and descriptors added to a search target image. By making the data size of descriptors smaller than that of the main body of an image, the processing load on the search system can be reduced and the load placed on the communication network can be reduced.

As an international standard related to such descriptors, there is known MPEG-7 Visual which is disclosed in Non-Patent Literature 1 (“MPEG-7 Visual Part of Experimentation Model Version 8.0”). Assuming applications such as high-speed image retrieval, MPEG-7 Visual defines formats for describing information such as the color and texture of an image and the shape and motion of an object appearing in an image.

Meanwhile, there is a technique in which moving image data is used as sensor data. For example, Patent Literature 1 (Japanese Patent Application Publication No. 2008-538870) discloses a video surveillance system capable of detecting or tracking a surveillance object (e.g., a person) appearing in a moving image which is obtained by a video camera, or detecting keep-staying of the surveillance object. By using the above-described MPEG-7 Visual technique, descriptors representing the shape and motion of such a surveillance object appearing in a moving image can be generated.

### CITATION LIST

### Patent Literature

Patent Literature 1: Japanese Patent Application Publication (Translation of PCT International Application) No. 2008-538870.

### Non-Patent Literature

Non-Patent Literature 1: A. Yamada, M. Pickering, S. Jeannin, L. Cieplinski, J.-R. Ohm, and M. Kim, Editors: MPEG-7 Visual Part of Experimentation Model Version 8.0 ISO/IEC JTC1/SC29/WG11/N3673, October 2000.

### SUMMARY OF INVENTION

### Technical Problem

A key point for when image data is used as sensor data is association between objects appearing in a plurality of captured images. For example, when objects representing the same target object appear in a plurality of captured images, by using the above-described MPEG-7 Visual technique, visual descriptors representing quantities of features such as the shapes, colors, and motions of the objects appearing in the captured images can be stored in storage together with the captured images. Then, by computation of similarity between the descriptors, a plurality of objects bearing high similarity are found from among a captured image group and the objects can be associated with each other.

However, for example, when a plurality of cameras capture the same target object in different directions, quantities of features (e.g., shape, color, and motion) of objects which are the same target object and appear in the captured images may greatly vary between the captured images. With such a case, there is the problem that association between the objects appearing in the captured images fails by the above-described similarity computation using descriptors. In addition, when a single camera captures a target object whose appearance shape changes, quantities of features of objects which are the target object and appear in a plurality of captured images may greatly vary between the captured images. In such a case, too, association between the objects appearing in the captured images may fail by the above-described similarity computation using descriptors.

In view of the above, an object of the present invention is to provide an image processing apparatus, image processing system, and image processing method that are capable of making highly accurate association between objects appearing in captured images.

### Solution to Problem

According to a first aspect of the present invention, there is provided an image processing apparatus which includes: an image analyzer configured to analyze an input image thereby to detect one or more objects appearing in the input image, and estimate quantities of one or more spatial features of the detected one or more objects with reference to real space; and a descriptor generator configured to generate one or more spatial descriptors representing the estimated quantities of one or more spatial features.

According to a second aspect of the present invention, there is provided an image processing system which includes: the image processing apparatus; a parameter deriving unit configured to derive a state parameter indicating a quantity of a state feature of an object group, based on the one or more spatial descriptors, the object group being a group of the detected objects; and a state predictor configured to predict, by computation, a future state of the object group based on the derived state parameter.

According to a third aspect of the present invention, there is provided an image processing method includes: analyzing an input image thereby to detect one or more objects appearing in the input image; estimating quantities of one or more spatial features of the detected one or more objects with reference to real space; and generating one or more spatial descriptors representing the estimated quantities of one or more spatial features.

### Advantageous Effects of Invention

According to the present invention, one or more spatial descriptors representing quantities of one or more spatial features of ono or more objects appearing in an input image, with reference to real space, are generated. By using the spatial descriptors as a search target, association between objects appearing in captured images can be performed with high accuracy and a low processing load. In addition, by analyzing the spatial descriptors, the state and behavior of the object can also be detected with a low processing load.

### BRIEF DESCRIPTION OF DRAWINGS

FIG. 1 is a block diagram showing a schematic configuration of an image processing system of a first embodiment according to the present invention.

FIG. 2 is a flowchart showing an example of the procedure of image processing according to the first embodiment.

FIG. 3 is a flowchart showing an example of the procedure of a first image analysis process according to the first embodiment.

FIG. 4 is a diagram exemplifying objects appearing in an input image.

FIG. 5 is a flowchart showing an example of the procedure of a second image analysis process according to the first embodiment.

FIG. 6 is a diagram for describing a method of analyzing a code pattern.

FIG. 7 is a diagram showing an example of a code pattern.

FIG. 8 is a diagram showing another example of a code pattern.

FIG. 9 is a diagram showing an example of a format of a spatial descriptor.

FIG. 10 is a diagram showing an example of a format of a spatial descriptor.

FIG. 11 is a diagram showing an example of a GNSS information descriptor.

FIG. 12 is a diagram showing an example of a GNSS information descriptor.

FIG. 13 is a block diagram showing a schematic configuration of an image processing system of a second embodiment according to the present invention.

FIG. 14 is a block diagram showing a schematic configuration of a security support system which is an image processing system of a third embodiment.

FIG. 15 is a diagram showing an exemplary configuration of a sensor having the function of generating descriptor data.

FIG. 16 is a diagram for describing an example of prediction performed by a community-state predictor of the third embodiment.

FIGS. 17A and 17B are diagrams showing an example of visual data generated by a state-presentation I/F unit of the third embodiment.

FIGS. 18A and 18B are diagrams showing another example of visual data generated by the state-presentation I/F unit of the third embodiment.

FIG. 19 is a diagram showing still another example of visual data generated by the state-presentation I/F unit of the third embodiment.

FIG. 20 is a block diagram showing a schematic configuration of a security support system which is an image processing system of a fourth embodiment.

### DESCRIPTION OF EMBODIMENTS

Various embodiments according to the present invention will be described in detail below with reference to the drawings. Note that those components denoted by the same reference signs throughout the drawings have the same configurations and the same functions.

### First Embodiment

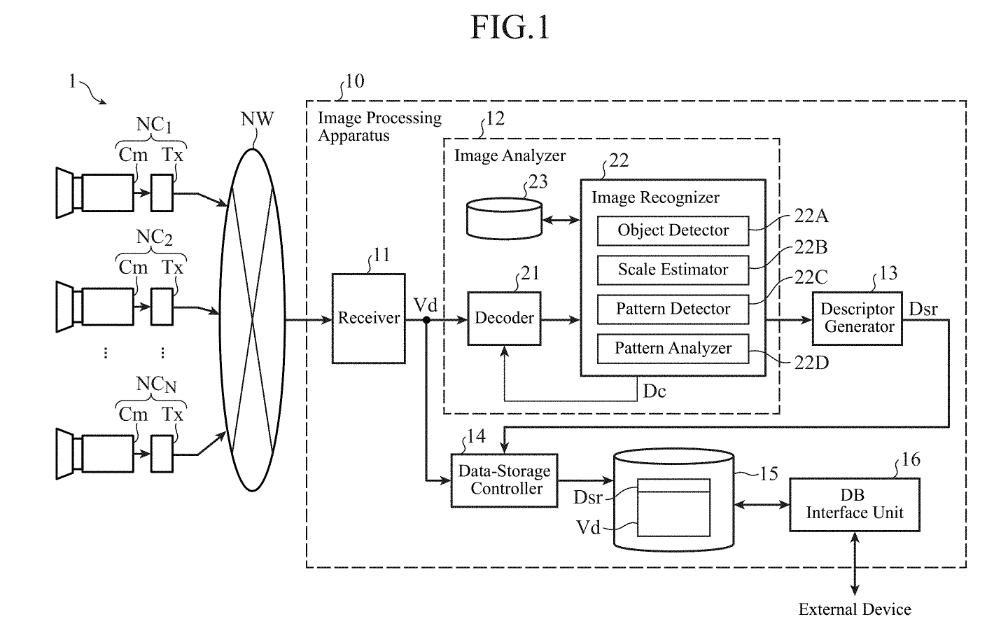

FIG. 1 is a block diagram showing a schematic configuration of an image processing system 1 of a first embodiment according to the present invention. As shown in FIG. 1, the image processing system 1 includes N network cameras NC₁, NC₂, . . . , NC_{N} (N is an integer greater than or equal to 3); and an image processing apparatus 10 that receives, through a communication network NW, still image data or a moving image stream transmitted by each of the network cameras NC₁, NC₂, . . . , NC_{N}. Note that the number of network cameras of the present embodiment is three or more, but may be one or two instead. The image processing apparatus 10 is an apparatus that performs image analysis on still image data or moving image data received from the network cameras NC₁ to NC_{N}, and stores a spatial or geographic descriptor representing the results of the analysis in a storage such that the descriptor is associated with an image.

Examples of the communication network NW include an on-premises communication network such as a wired LAN (Local Area Network) or a wireless LAN, a dedicated network which connects locations, and a wide-area communication network such as the Internet.

The network cameras NC₁ to NC_{N} all have the same configuration. Each network camera is composed of an imaging unit Cm that captures a subject; and a transmitter Tx that transmits an output from the imaging unit Cm, to the image processing apparatus 10 on the communication network NW. The imaging unit Cm includes an imaging optical system that forms an optical image of the subject; a solid-state imaging device that converts the optical image into an electrical signal; and an encoder circuit that compresses/encodes the electrical signal as still image data or moving image data. For the solid-state imaging device, for example, a CCD (Charge-Coupled Device) or CMOS (Complementary Metal-oxide Semiconductor) device may be used.

When an output from the solid-state imaging device is compressed/encoded as moving image data, each of the network cameras NC₁ to NC_{N} can generate a compressed/encoded moving image stream according to a streaming system, e.g., MPEG-2 TS (Moving Picture Experts Group 2 Transport Stream), RTP/RTSP (Real-time Transport Protocol/Real Time Streaming Protocol), MMT (MPEG Media Transport), or DASH (Dynamic Adaptive Streaming over HTTP). Note that the streaming systems used in the present embodiment are not limited to MPEG-2 TS, RTP/RTSP, MMT, and DASH. Note, however, that in any of the streaming systems, identification information that allows the image processing apparatus 10 to uniquely separate moving image data included in a moving image stream needs to be multiplexed into the moving image stream.

On the other hand, the image processing apparatus 10 includes, as shown in FIG. 1, a receiver 11 that receives transmitted data from the network cameras NC₁ to NC_{N} and separates image data Vd (including still image data or a moving image stream) from the transmitted data; an image analyzer 12 that analyzes the image data Vd inputted from the receiver 11; a descriptor generator 13 that generates, based on the results of the analysis, a spatial descriptor, a geographic descriptor, an MPEG standard descriptor, or descriptor data Dsr representing a combination of those descriptors; a data-storage controller 14 that associates the image data Vd inputted from the receiver 11 and the descriptor data Dsr with each other and stores the image data Vd and the descriptor data Dsr in a storage 15; and a DB interface unit 16. When the transmitted data includes a plurality of pieces of moving image content, the receiver 11 can separate the plurality of pieces of moving image content from the transmitted data according to their protocols such that the plurality of pieces of moving image content can be uniquely recognized.

The image analyzer 12 includes, as shown in FIG. 1, a decoder 21 that decodes the compressed/encoded image data Vd, according to a compression/encoding system used by the network cameras NC₁ to NO_{N}; an image recognizer 22 that performs an image recognition process on the decoded data; and a pattern storage unit 23 which is used in the image recognition process. The image recognizer 22 further includes an object detector 22A, a scale estimator 22B, a pattern detector 22C, and a pattern analyzer 22D.

The object detector 22A analyzes a single or plurality of input images represented by the decoded data, to detect an object appearing in the input image. The pattern storage unit 23 stores in advance, for example, patterns representing features such as the two-dimensional shapes, three-dimensional shapes, sizes, and colors of a wide variety of objects such as the human body, e.g., pedestrians, traffic lights, signs, automobiles, bicycles, and buildings. The object detector 22A can detect an object appearing in the input image by comparing the input image with the patterns stored in the pattern storage unit 23.

The scale estimator 22B has the function of estimating, as scale information, one or more quantities of spatial features of the object detected by the object detector 22A with reference to real space which is the actual imaging environment. It is preferred to estimate, as the quantity of the spatial feature of the object, a quantity representing the physical dimension of the object in the real space (hereinafter, also simply referred to as “physical quantity”). Specifically, when the scale estimator 22B refers to the pattern storage unit 23 and the physical quantity (e.g., a height, a width, or an average value of heights or widths) of an object detected by the object detector 22A is already stored in the pattern storage unit 23, the scale estimator 22B can obtain the stored physical quantity as the physical quantity of the object. For example, in the case of objects such as a traffic light and a sign, since the shapes and dimensions thereof are already known, a user can store the numerical values of the shapes and dimensions thereof beforehand in the pattern storage unit 23. In addition, in the case of objects such as an automobile, a bicycle, and a pedestrian, since variation in the numerical values of the shapes and dimensions of the objects is within a certain range, the user can also store the average values of the shapes and dimensions thereof beforehand in the pattern storage unit 23. In addition, the scale estimator 22B can also estimate the attitude of each of the objects (e.g., a direction in which the object faces) as a quantity of a spatial feature.

Furthermore, when the network cameras NC₁ to NC_{N} have a three-dimensional image creating function of a stereo camera, a range camera, or the like, the input image includes not only strength information of an object, but also depth information of the object. In this case, the scale estimator 22B can obtain, based on the input image, the depth information of the object as one physical dimension.

The descriptor generator 13 can convert the quantity of a spatial feature estimated by the scale estimator 22B into a descriptor, according to a predetermined format. Here, imaging time information is added to the spatial descriptor. An example of the format of the spatial descriptor will be described later.

On the other hand, the image recognizer 22 has the function of estimating geographic information of an object detected by the object detector 22A. The geographic information is, for example, positioning information indicating the location of the detected object on the Earth. The function of estimating geographic information is specifically implemented by the pattern detector 22C and the pattern analyzer 22D.

The pattern detector 22C can detect a code pattern in the input image. The code pattern is detected near a detected object; for example, a spatial code pattern such as a two-dimensional code, or a chronological code pattern such as a pattern in which light blinks according to a predetermined rule can be used. Alternatively, a combination of a spatial code pattern and a chronological code pattern may be used. The pattern analyzer 22D can analyze the detected code pattern to detect positioning information.

The descriptor generator 13 can convert the positioning information detected by the pattern detector 22C into a descriptor, according to a predetermined format. Here, imaging time information is added to the geographic descriptor. An example of the format of the geographic descriptor will be described later.

In addition, the descriptor generator 13 also has the function of generating known MPEG standard descriptors (e.g., visual descriptors representing quantities of features such as the color, texture, shape, and motion of an object, and a face) in addition to the above-described spatial descriptor and geographic descriptor. The above-described known descriptors are defined in, for example, MPEG-7 and thus a detailed description thereof is omitted.

The data-storage controller 14 stores the image data Vd and the descriptor data Dsr in the storage 15 so as to structure a database. An external device can access the database in the storage 15 through the DB interface unit 16.

For the storage 15, for example, a large-capacity storage medium such as an HDD (Hard Disk Drive) or a flash memory may be used. The storage 15 is provided with a first data storing unit in which the image data Vd is stored; and a second data storing unit in which the descriptor data Dsr is stored. Note that although in the present embodiment the first data storing unit and the second data storing unit are provided in the same storage 15, the configuration is not limited thereto. The first data storing unit and the second data storing unit may be provided in different storages in a distributed manner. In addition, although the storage 15 is built in the image processing apparatus 10, the configuration is not limited thereto. The configuration of the image processing apparatus 10 may be changed so that the data-storage controller 14 can access a single or plurality of network storage apparatuses disposed on a communication network. By this, the data-storage controller 14 can construct an external database by storing image data Vd and descriptor data Dsr in an external storage.

The above-described image processing apparatus 10 can be configured using, for example, a computer including a CPU (Central Processing Unit) such as a PC (Personal Computer), a workstation, or a mainframe. When the image processing apparatus 10 is configured using a computer, the functions of the image processing apparatus 10 can be implemented by a CPU operating according to an image processing program which is read from a nonvolatile memory such as a ROM (Read Only Memory).

In addition, all or some of the functions of the components 12, 13, 14, and 16 of the image processing apparatus 10 may be composed of a semiconductor integrated circuit such as an FPGA (Field-Programmable Gate Array) or an ASIC (Application Specific Integrated Circuit), or may be composed of a one-chip microcomputer which is a type of microcomputer.

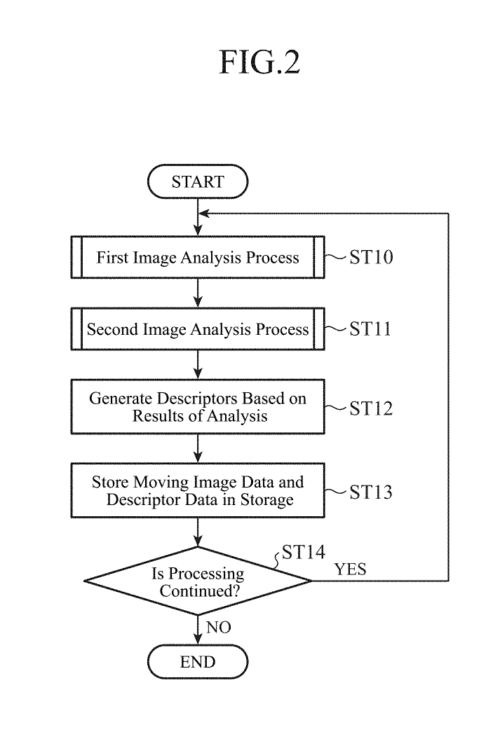

Next, the operation of the above-described image processing apparatus 10 will be described. FIG. 2 is a flowchart showing an example of the procedure of image processing according to the first embodiment. FIG. 2 shows an example case in which compressed/encoded moving image streams are received from the network cameras NC₁, NC₂, . . . , NC_{N}.

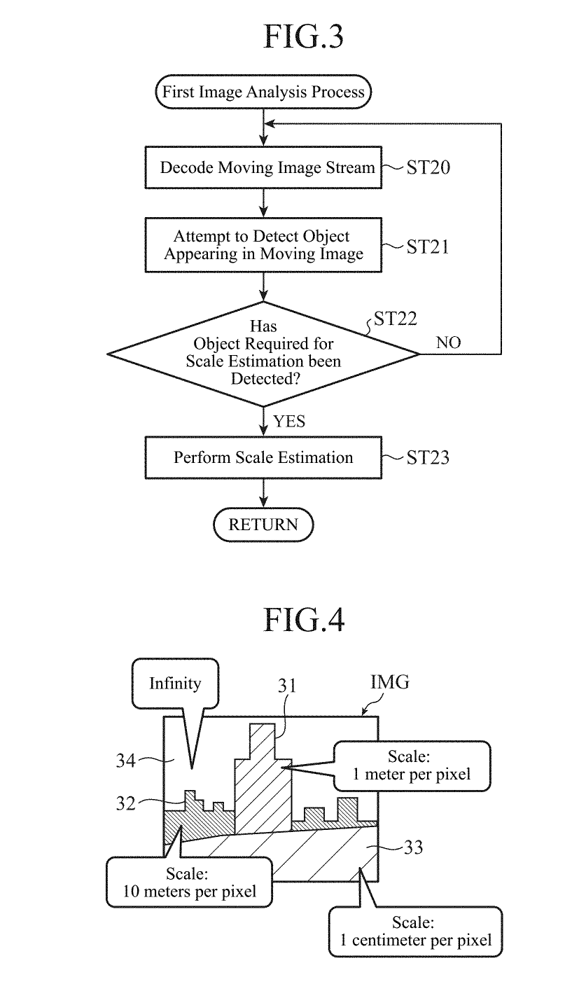

When image data Vd is inputted from the receiver 11, the decoder 21 and the image recognizer 22 perform a first image analysis process (step ST10). FIG. 3 is a flowchart showing an example of the first image analysis process.

Referring to FIG. 3, the decoder 21 decodes an inputted moving image stream and outputs decoded data (step ST20). Then, the object detector 22A attempts to detect, using the pattern storage unit 23, an object that appears in a moving image represented by the decoded data (step ST21). A detection target is desirably, for example, an object whose size and shape are known, such as a traffic light or a sign, or an object which appears in various variations in the moving image and whose average size matches a known average size with sufficient accuracy, such as an automobile, a bicycle, or a pedestrian. In addition, the attitude of the object with respect to a screen (e.g., a direction in which the object faces) and depth information may be detected.

If an object required to perform estimation of one or more quantities of a spatial feature, i.e., scale information, of the object (hereinafter, also referred to as “scale estimation”) has not been detected by the execution of step ST21 (NO at step ST22), the processing procedure returns to step ST20. At this time, the decoder 21 decodes a moving image stream in response to a decoding instruction Dc from the image recognizer 22 (step ST20). Thereafter, step ST21 and subsequent steps are performed. On the other hand, if an object required for scale estimation has been detected (YES at step ST22), the scale estimator 22B performs scale estimation on the detected object (step ST23). In this example, as the scale information of the object, a physical dimension per pixel is estimated.

For example, when an object and its attitude have been detected, the scale estimator 22B compares the results of the detection with corresponding dimension information held in advance in the pattern storage unit 23, and can thereby estimate scale information based on pixel regions where the object is displayed (step ST23). For example, when, in an input image, a sign with a diameter of 0.4 m is displayed facing right in front of an imaging camera and the diameter of the sign is equivalent to 100 pixels, the scale of the object is 0.004 m/pixel. FIG. 4 is a diagram exemplifying objects 31, 32, 33, and 34 appearing in an input image IMG. The scale of the object 31 which is a building is estimated to be 1 meter/pixel, the scale of the object 32 which is another building is estimated to be 10 meters/pixel, and the scale of the object 33 which is a small structure is estimated to be 1 cm/pixel. In addition, the distance to the background object 34 is considered to be infinity in real space, and thus, the scale of the background object 34 is estimated to be infinity.

In addition, when the detected object is an automobile or a pedestrian, or an object that is present on the ground and disposed in a roughly fixed position with respect to the ground such as a guardrail, it is highly likely that an area where that kind of object is present is an area where the object can move and an area where the object is held onto a specific plane. Thus, the scale estimator 22B can also detect a plane on which an automobile or a pedestrian moves, based on the holding condition, and derive a distance to the plane based on an estimated value of the physical dimension of an object that is the automobile or pedestrian, and based on knowledge about the average dimension of the automobile or pedestrian (knowledge stored in the pattern storage unit 23). Thus, even when scale information of all objects appearing in an input image cannot be estimated, an area including a point where an object is displayed or an area including a road that is an important target for obtaining scale information, etc., can be detected without any special sensor.

Note that if an object required for scale estimation has not been detected even after the passage of a certain period of time (NO at step ST22), the first image analysis process may be completed.

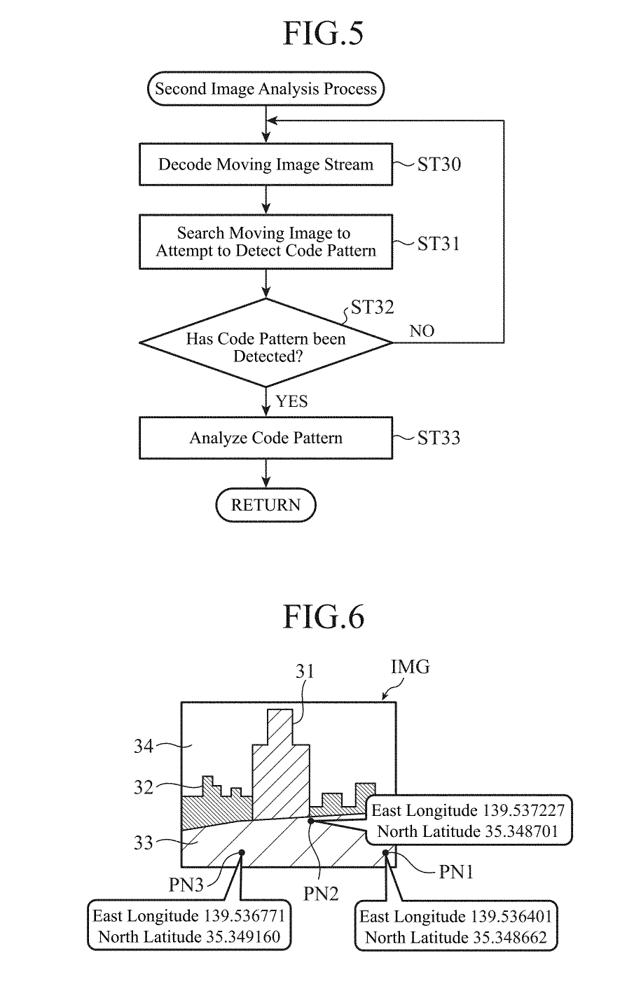

After the completion of the first image analysis process (step ST10), the decoder 21 and the image recognizer 22 perform a second image analysis process (step ST11). FIG. 5 is a flowchart showing an example of the second image analysis process.

Referring to FIG. 5, the decoder 21 decodes an inputted moving image stream and outputs decoded data (step ST30). Then, the pattern detector 22C searches a moving image represented by the decoded data, to attempt to detect a code pattern (step ST31). If a code pattern has not been detected (NO at step ST32), the processing procedure returns to step ST30. At this time, the decoder 21 decodes a moving image stream in response to a decoding instruction Dc from the image recognizer 22 (step ST30). Thereafter, step ST31 and subsequent steps are performed. On the other hand, if a code pattern has been detected (YES at step ST32), the pattern analyzer 22D analyzes the code pattern to obtain positioning information (step ST33).

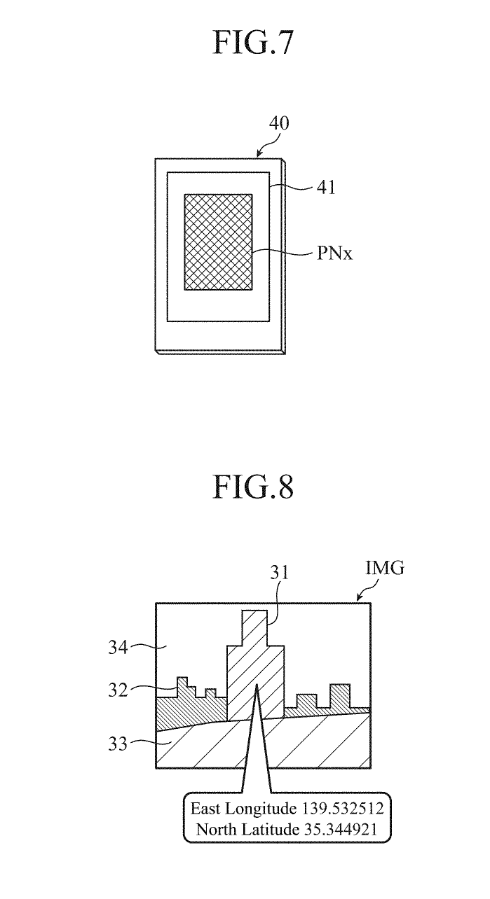

FIG. 6 is a diagram showing an example of the results of pattern analysis performed on the input image IMG shown in FIG. 4. In this example, code patterns PN1, PN2, and PN3 appearing in the input image IMG are detected, and as the results of analysis of the code patterns PN1, PN2, and PN3, absolute coordinate information which is latitude and longitude represented by each code pattern is obtained. The code patterns PN1, PN2, and PN3 which are visible as dots in FIG. 6 are spatial patterns such as two-dimensional codes, chronological patterns such as light blinking patterns, or a combination thereof. The pattern detector 22C can analyze the code patterns PN1, PN2, and PN3 appearing in the input image IMG, to obtain positioning information. FIG. 7 is a diagram showing a display device 40 that displays a spatial code pattern PNx. The display device 40 has the function of receiving a Global Navigation Satellite System (GNSS) navigation signal, measuring a current location thereof based on the navigation signal, and displaying a code pattern PNx representing positioning information thereof on a display screen 41. By disposing such a display device 40 near an object, as shown in FIG. 8, positioning information of the object can be obtained.

Note that positioning information obtained using GNSS is also called GNSS information. For GNSS, for example, GPS (Global Positioning System) operated by the United States of America, GLONASS (GLObal NAvigation Satellite System) operated by the Russian Federation, the Galileo system operated by the European Union, or Quasi-Zenith Satellite System operated by Japan can be used.

Note that if a code pattern has not been detected even after the passage of a certain period of time (NO at step ST32), the second image analysis process may be completed.

Then, referring to FIG. 2, after the completion of the second image analysis process (step ST11), the descriptor generator 13 generates a spatial descriptor representing the scale information obtained at step ST23 of FIG. 3, and generates a geographic descriptor representing the positioning information obtained at step ST33 of FIG. 5 (step ST12). Then, the data-storage controller 14 associates the moving image data Vd and descriptor data Dsr with each other and stores the moving image data Vd and descriptor data Dsr in the storage 15 (step ST13). Here, it is preferred that the moving image data Vd and the descriptor data Dsr be stored in a format that allows high-speed bidirectional access. A database may be structured by creating an index table indicating the correspondence between the moving image data Vd and the descriptor data Dsr. For example, when a data location of a specific image frame composing the moving image data Vd is given, index information can be added so that a storage location in the storage of descriptor data corresponding to the data location can be identified at high speed. In addition, to facilitate reverse access, too, index information may be created.

Thereafter, if the processing continues (YES at step ST14), the above-described steps ST10 to ST13 are repeatedly performed. By this, moving image data Vd and descriptor data Dsr are stored in the storage 15. On the other hand, if the processing is discontinued (NO at step ST14), the image processing ends.

Next, examples of the formats of the above-described spatial and geographic descriptors will be described.

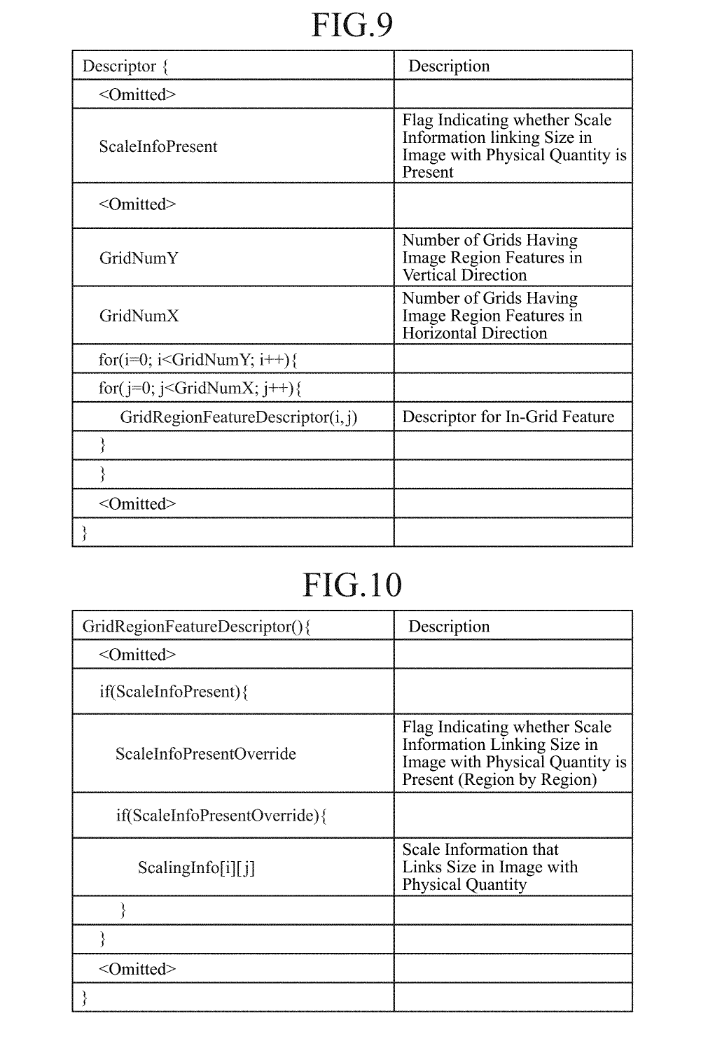

FIGS. 9 and 10 are diagrams showing examples of the format of a spatial descriptor. The examples of FIGS. 9 and 10 show descriptions for each grid obtained by spatially dividing an input image into a grid pattern. As shown in FIG. 9, the flag “ScaleInfoPresent” is a parameter indicating whether scale information that links (associates) the size of a detected object with the physical quantity of the object is present. The input image is divided into a plurality of image regions, i.e., grids, in a spatial direction. “GridNumX” indicates the number of grids in a vertical direction where image region features indicating the features of the object are present, and “GridNumY” indicates the number of grids in a horizontal direction where image region features indicating the features of the object are present. “GridRegionFeatureDescriptor(i, j)” is a descriptor representing a partial feature (in-grid feature) of the object for each grid.

FIG. 10 is a diagram showing the contents of the descriptor “GridRegionFeatureDescriptor(i, j)”. Referring to FIG. 10, “ScaleInfoPresentOverride” denotes a flag indicating, grid by grid (region by region), whether scale information is present. “ScalingInfo[i] [j]” denotes a parameter indicating scale information present at the (i, j)-th grid, where i denotes the grid number in the vertical direction and j denotes the grid number in the horizontal direction. As such, scale information can be defined for each grid of the object appearing in the input image. Note that since there is also a region whose scale information cannot be obtained or whose scale information is not necessary, whether to describe on a grid-by-grid-basis can be specified by the parameter “ScalelnfoPresentOverride”.

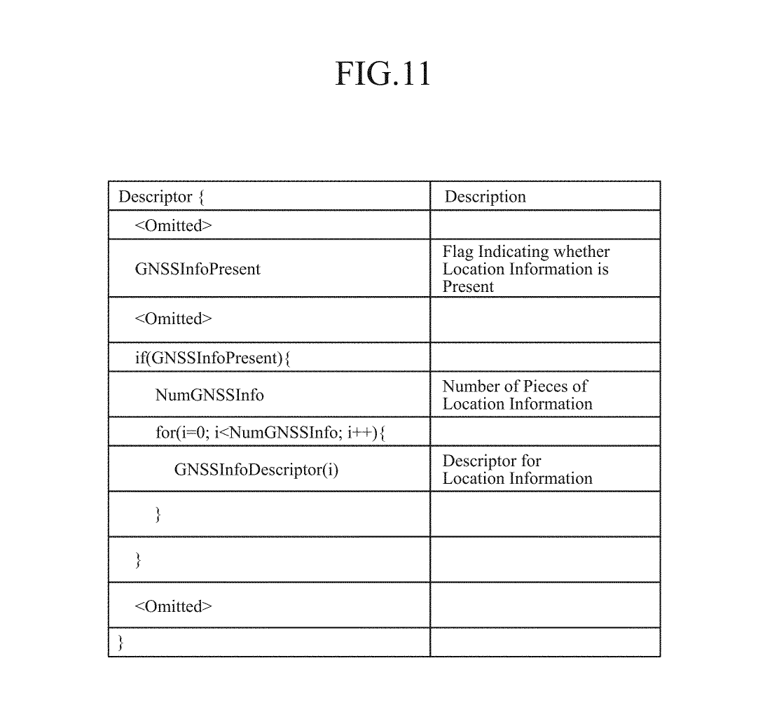

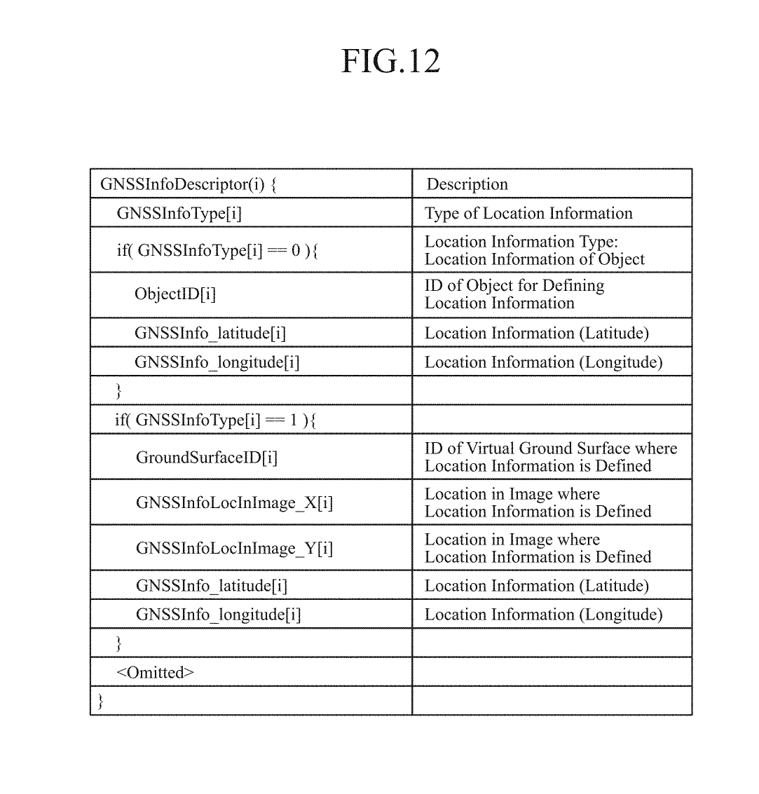

Next, FIGS. 11 and 12 are diagrams showing examples of the format of a GNSS information descriptor. Referring to FIG. 11, “GNSSInfoPresent” denotes a flag indicating whether location information which is measured as GNSS information is present. “NumGNSSInfo” denotes a parameter indicating the number of pieces of location information.

“GNSSInfoDescriptor(i)” denotes a descriptor for an i-th location information. Since location information is defined by a dot region in the input image, the number of pieces of location information is transmitted through the parameter “NumGNSSInfo” and then the GNSS information descriptors “GNSSInfoDescriptor(i)” corresponding to the number of the pieces of location information are described.

FIG. 12 is a diagram showing the contents of the descriptor “GNSSInfoDescriptor(i)”. Referring to FIG. 12, “GNSSInfoType[i]” is a parameter indicating the type of an i-th location information. For the location information, location information of an object which is a case of GNSSInfoType[i]=0 and location information of a thing other than an object which is a case of GNSSInfoType[i]=1 can be described. For the location information of an object, “ObjectID[i]” is an ID (identifier) of the object for defining location information. In addition, for each object, “GNSSInfo_latitude[i]” indicating latitude and “GNSSInfo_longitude[i]” indicating longitude are described.

On the other hand, for the location information of a thing other than an object, “GroundSurfaceID[i]” shown in FIG. 12 is an ID (identifier) of a virtual ground surface where location information measured as GNSS information is defined, “GNSSInfoLocInImage_X[i]” is a parameter indicating a location in the horizontal direction in the image where the location information is defined, and “GNSSInfoLocInImage_Y[i]” is a parameter indicating a location in the vertical direction in the image where the location information is defined. For each ground surface, “GNSSInfo_latitude[i]” indicating latitude and “GNSSInfo_longitude[i]” indicating longitude are described. Location information is information by which, when an object is held onto a specific plane, the plane displayed on the screen can be mapped onto a map. Hence, an ID of a virtual ground surface where GNSS information is present is described. In addition, it is also possible to describe GNSS information for an object displayed in an image. This assumes an application in which GNSS information is used to search for a landmark, etc.

Note that the descriptors shown in FIGS. 9 to 12 are examples, and thus, addition or deletion of any information to/from the descriptors as well as changes of the order or configurations of the descriptors can be made.

As described above, in the first embodiment, a spatial descriptor for an object appearing in an input image can be associated with image data and stored in the storage 15. By using the spatial descriptor as a search target, association between objects which appear in captured images and have close relationships with one another in a spatial or spatio-temporal manner can be performed with high accuracy and a low processing load. Hence, for example, even when a plurality of network cameras NC₁ to NC_{N} capture images of the same target object in different directions, by computation of similarity between descriptors stored in the storage 15, association between objects appearing in the captured images can be performed with high accuracy.

In addition, in the present embodiment, a geographic descriptor for an object appearing in an input image can also be associated with image data and stored in the storage 15. By using a geographic descriptor together with a spatial descriptor as search targets, association between objects appearing in captured images can be performed with higher accuracy and a low processing load.

Therefore, by using the image processing system 1 of the present embodiment, for example, automatic recognition of a specific object, creation of a three-dimensional map, or image retrieval can be efficiently performed.

### Second Embodiment

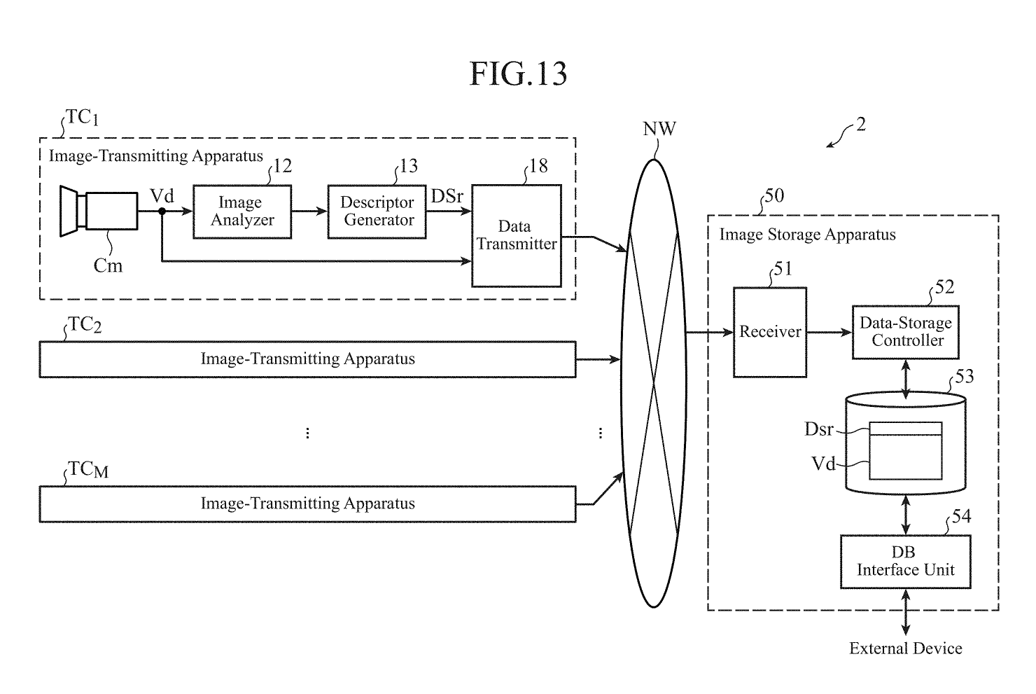

Next, a second embodiment according to the present invention will be described. FIG. 13 is a block diagram showing a schematic configuration of an image processing system 2 of the second embodiment.

As shown in FIG. 13, the image processing system 2 includes M image-transmitting apparatuses TC₁, TC₂, . . . , TC_{M} (M is an integer greater than or equal to 3) which function as image processing apparatuses; and an image storage apparatus 50 that receives, through a communication network NW, data transmitted by each of the image-transmitting apparatuses TC₁, TC₂, . . . , TC_{M}. Note that in the present embodiment the number of image-transmitting apparatuses is three or more, but may be one or two instead.

The image-transmitting apparatuses TC₁, TC₂, . . . , TC_{M} all have the same configuration. Each image-transmitting apparatus is configured to include an imaging unit Cm, an image analyzer 12, a descriptor generator 13, and a data transmitter 18. The configurations of the imaging unit Cm, the image analyzer 12, and the descriptor generator 13 are the same as those of the imaging unit Cm, the image analyzer 12, and the descriptor generator 13 of the above-described first embodiment, respectively. The data transmitter 18 has the function of associating image data Vd with descriptor data Dsr, and multiplexing and transmitting the image data Vd and the descriptor data Dsr to the image storage apparatus 50, and the function of delivering only the descriptor data Dsr to the image storage apparatus 50.

The image storage apparatus 50 includes a receiver 51 that receives transmitted data from the image-transmitting apparatuses TC₁, TC₂, . . . , TC_{M} and separates data streams (including one or both of image data Vd and descriptor data Dsr) from the transmitted data; a data-storage controller 52 that stores the data streams in a storage 53; and a DB interface unit 54. An external device can access a database in the storage 53 through the DB interface unit 54.

As described above, in the second embodiment, spatial and geographic descriptors and their associated image data can be stored in the storage 53. Therefore, by using the spatial descriptor and the geographic descriptor as search targets, as in the case of the first embodiment, association between objects appearing in captured images and having close relationships with one another in a spatial or spatio-temporal manner can be performed with high accuracy and a low processing load. Therefore, by using the image processing system 2, for example, automatic recognition of a specific object, creation of a three-dimensional map, or image retrieval can be efficiently performed.

### Third Embodiment

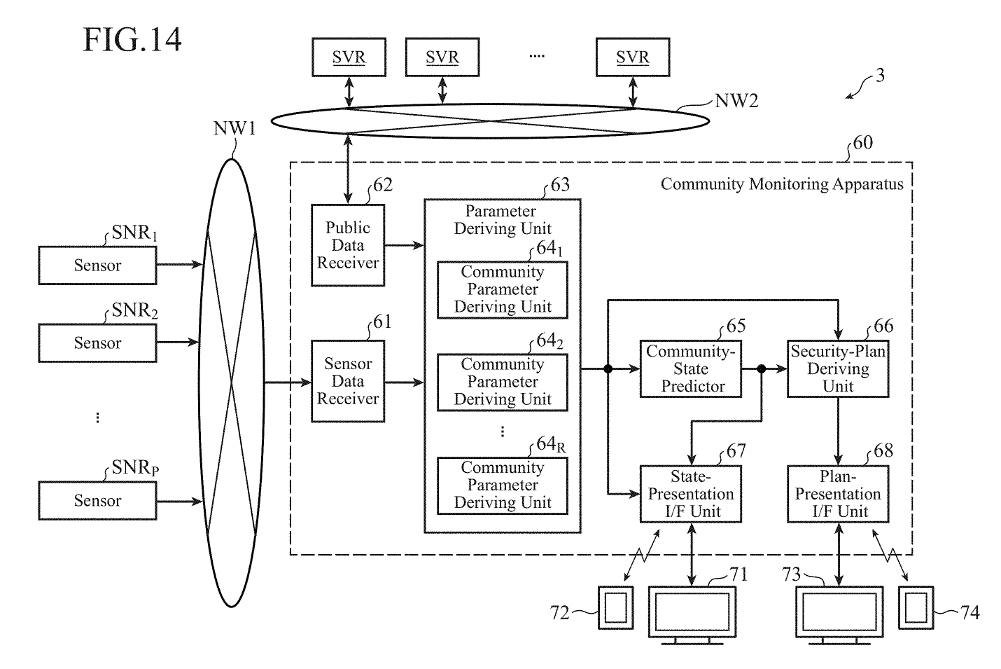

Next, a third embodiment according to the present invention will be described. FIG. 14 is a block diagram showing a schematic configuration of a security support system 3 which is an image processing system of the third embodiment.

The security support system 3 can be operated, targeting a crowd present in a location such as an in-facility, an event venue, or a city area, and persons in charge of security located in that location. In a location where a large number of individuals forming a group, i.e., a crowd (including persons in charge of security), gather such as an in-facility, an event venue, or a city area, congestion may frequently occur. Congestion impairs the comfort of a crowd in that location and also dense congestion causes a crowd accident, and thus, it is very important to avoid congestion by appropriate security. In addition, it is also important in terms of crowd safety to promptly find an injured individual, an individual not feeling well, a vulnerable road user, and an individual or group of individuals who engage in dangerous behaviors, to take appropriate security measures.

The security support system 3 of the present embodiment can grasp and predict the states of a crowd in a single or plurality of target areas, based on sensor data obtained from sensors SNR₁, SNR₂, . . . , SNR_{P} which are disposed in the target areas in a distributed manner and based on public data obtained from server devices SVR, SVR, . . . , SVR on a communication network NW2. In addition, the security support system 3 can derive, by computation, information indicating the past, present, and future states of the crowds which are processed in a user understandable format and an appropriate security plan, based on the grasped or predicted states, and can present the information and the security plan to persons in charge of security or the crowds as information useful for security support.

Referring to FIG. 14, the security support system 3 includes P sensors SNR₁, SNR₂, . . . , SNR_{P} where P is an integer greater than or equal to 3; and a community monitoring apparatus 60 that receives, through a communication network NW1, sensor data transmitted by each of the sensors SNR₁, SNR₂, . . . , SNR_{P}. In addition, the community monitoring apparatus 60 has the function of receiving public data from each of the server devices SVR, . . . , SVR through the communication network NW2. Note that the number of sensors SNR₁ to SNR_{P} of the present embodiment is three or more, but may be one or two instead.

The server devices SVR, SVR, . . . , SVR have the function of transmitting public data such as SNS (Social Networking Service/Social Networking Site) information and public information. SNS indicates social networking services or social networking sites with a high level of real-time interaction where content posted by users is made public, such as Twitter (registered trademark) or Facebook (registered trademark). SNS information is information made public by/on that kind of social networking services or social networking sites. In addition, examples of the public information include traffic information and weather information which are provided by an administrative unit, such as a self-governing body, public transport, and a weather service.

Examples of the communication networks NW1 and NW2 include an on-premises communication network such as a wired LAN or a wireless LAN, a dedicated network which connects locations, and a wide-area communication network such as the Internet. Note that although the communication networks NW1 and NW2 of the present embodiment are constructed to be different from each other, the configuration is not limited thereto. The communication networks NW1 and NW2 may form a single communication network.

The community monitoring apparatus 60 includes a sensor data receiver 61 that receives sensor data transmitted by each of the sensors SNR₁, SNR₂, . . . , SNR_{P}; a public data receiver 62 that receives public data from each of the server devices SVR, . . . , SVR through the communication network NW2; a parameter deriving unit 63 that derives, by computation, state parameters indicating the quantities of the state features of a crowd which are detected by the sensors SNR₁ to SNR_{P}, based on the sensor data and the public data; a community-state predictor 65 that predicts, by computation, a future state of the crowd based on the present or past state parameters; and a security-plan deriving unit 66 that derives, by computation, a proposed security plan based on the result of the prediction and the state parameters.

Furthermore, the community monitoring apparatus 60 includes a state presentation interface unit (state-presentation I/F unit) 67 and a plan presentation interface unit (plan-presentation I/F unit) 68. The state-presentation I/F unit 67 has a computation function of generating visual data or sound data representing the past, present, and future states of the crowd (the present state includes a real-time changing state) in an easy-to-understand format for users, based on the result of the prediction and the state parameters; and a communication function of transmitting the visual data or the sound data to external devices 71 and 72. On the other hand, the plan-presentation I/F unit 68 has a computation function of generating visual data or sound data representing the proposed security plan derived by the security-plan deriving unit 66, in an easy-to-understand format for the users; and a communication function of transmitting the visual data or the sound data to external devices 73 and 74.

Note that although the security support system 3 of the present embodiment is configured to use an object group, i.e., a crowd, as a sensing target, the configuration is not limited thereto. The configuration of the security support system 3 can be changed as appropriate such that a group of moving objects other than the human body (e.g., living organisms such as wild animals or insects, or vehicles) is used as an object group which is a sensing target.

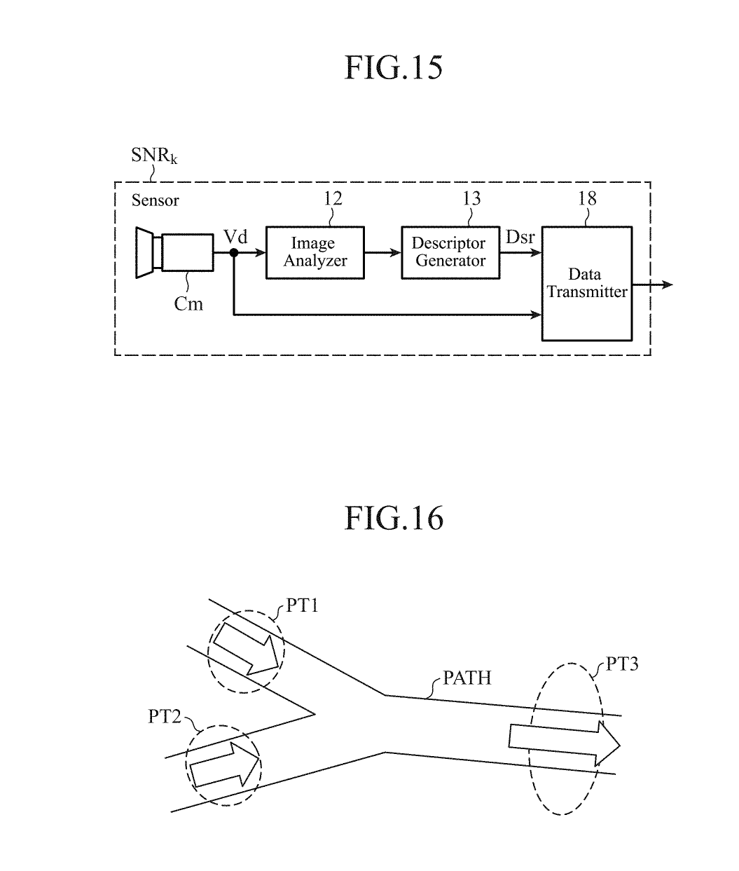

Each of the sensors SNR₁, SNR₂, . . . , SNR_{P} electrically or optically detects a state of a target area and thereby generates a detection signal, and generates sensor data by performing signal processing on the detection signal. The sensor data includes processed data representing content which is an abstract or compact version of detected content represented by the detection signal. For the sensors SNR₁ to SNR_{P}, various types of sensors can be used in addition to sensors having the function of generating descriptor data Dsr according to the above-described first and second embodiments. FIG. 15 is a diagram showing an example of a sensor SNRₖ having the function of generating descriptor data Dsr. The sensor SNRₖ shown in FIG. 15 has the same configuration as the image-transmitting apparatus TC₁ of the above-described second embodiment.

In addition, the types of the sensors SNR₁ to SNR_{P} are broadly divided into two types: a fixed sensor which is installed at a fixed location and a mobile sensor which is mounted on a moving object. For the fixed sensor, for example, an optical camera, a laser range sensor, an ultrasonic range sensor, a sound-collecting microphone, a thermographic camera, a night vision camera, and a stereo camera can be used. On the other hand, for the mobile sensor, for example, a positioning device, an acceleration sensor, and a vital sensor can be used in addition to sensors of the same type as the fixed sensors. The mobile sensor can be mainly used for an application in which the mobile sensor performs sensing while moving with an object group which is a sensing target, by which the motion and state of the object group is directly sensed. In addition, a device that accepts an input of subjective data representing a result of observation of a state of an object group which is performed by a human may be used as a part of a sensor. This kind of device can, for example, supply the subjective data as sensor data through a mobile communication terminal such as a portable terminal carried by the human.

Note that the sensors SNR₁ to SNR_{P} may be configured by only sensors of a single type or may be configured by sensors of a plurality of types.

Each of the sensors SNR₁ to SNR_{P} is installed in a location where a crowd can be sensed, and can transmit a result of sensing of the crowd as necessary while the security support system 3 is in operation. A fixed sensor is installed on, for example, a street light, a utility pole, a ceiling, or a wall. A mobile sensor is mounted on a moving object such as a security guard, a security robot, or a patrol vehicle. In addition, a sensor attached to a mobile communication terminal such as a smartphone or a wearable device carried by each of individuals forming a crowd or by a security guard may be used as the mobile sensor. In this case, it is desirable to construct in advance a framework for collecting sensor data so that application software for sensor data collection can be installed in advance on a mobile communication terminal carried by each of individuals forming a crowd which is a security target or by a security guard.

When the sensor data receiver 61 in the community monitoring apparatus 60 receives a sensor data group including descriptor data Dsr from the above-described sensors SNR₁ to SNR_{P} through the communication network NW1, the sensor data receiver 61 supplies the sensor data group to the parameter deriving unit 63. On the other hand, when the public data receiver 62 receives a public data group from the server devices SVR, . . . , SVR through the communication network NW2, the public data receiver 62 supplies the public data group to the parameter deriving unit 63.

The parameter deriving unit 63 can derive, by computation, state parameters indicating the quantities of the state features of a crowd detected by any of the sensors SNR₁ to SNR_{P}, based on the supplied sensor data group and public data group. The sensors SNR₁ to SNR_{P} include a sensor having the configuration shown in FIG. 15. As described in the second embodiment, this kind of sensor can analyze a captured image to detect a crowd appearing in the captured image, as an object group, and transmit descriptor data Dsr representing the quantities of spatial, geographic, and visual features of the detected object group to the community monitoring apparatus 60. In addition, the sensors SNR₁ to SNR_{P} include, as described above, a sensor that transmits sensor data (e.g., body temperature data) other than descriptor data Dsr to the community monitoring apparatus 60. Furthermore, the server devices SVR, . . . , SVR can provide the community monitoring apparatus 60 with public data related to a target area where the crowd is present, or related to the crowd. The parameter deriving unit 63 includes community parameter deriving units 64₁, 64₂, . . . , 64_{R} that analyze such a sensor data group and a public data group to derive R types of state parameters (R is an integer greater than or equal to 3), respectively, the R types of state parameters indicating the quantities of the state features of the crowd. Note that the number of community parameter deriving units 64₁ to 64_{R} of the present embodiment is three or more, but may be one or two instead.

Examples of the types of state parameters include a “crowd density”, “motion direction and speed of a crowd”, a “flow rate”, a “type of crowd behavior”, a “result of extraction of a specific individual”, and a “result of extraction of an individual in a specific category”.

Here, the “flow rate” is defined, for example, as a value (unit: the number of individuals times a meter per second) which is obtained by multiplying a value indicating the number of individuals passing through a predetermined region per unit time, by the length of the predetermined region. In addition, examples of the “type of crowd behavior” include a “one-direction flow” in which a crowd flows in one direction, “opposite-direction flows” in which flows in opposite directions pass each other, and “staying” in which a crowd keeps staying where they are. In addition, the “staying” can also be classified into two types: one type is “uncontrolled staying” indicating, for example, a state in which the crowd is unable to move due to too much crowd density, and the another type is “controlled staying” that occur when the crowd stops moving in response to an organizer's instruction.

In addition, the “result of extraction of a specific individual” is information indicating whether a specific individual is present in a target area of the sensor, and track information obtained as a result of tracking the specific individual. This kind of information can be used to create information indicating whether a specific individual which is a search target is present in the entire sensing range of the security support system 3, and is, for example, information useful for finding a lost child.

The “result of extraction of an individual in a specific category” is information indicating whether an individual belonging to a specific category is present in a target area of the sensor, and track information obtained as a result of tracking the specific individual. Here, examples of the individual belonging to a specific category include an “individual with specific age and gender”, a “vulnerable road user” (e.g., an infant, the elderly, a wheelchair user, and a white cane user), and “an individual or group of individuals who engage in dangerous behaviors”. This kind of information is information useful for determining whether a special security system is required for the crowd.

In addition, the community parameter deriving units 64₁ to 64_{R} can also derive state parameters such as a “subjective degree of congestion”, a “subjective comfort”, a “status of the occurrence of trouble”, “traffic information”, and “weather information”, based on public data provided from the server devices SVR.

The above-described state parameters may be derived based on sensor data which is obtained from a single sensor, or may be derived by integrating and using a plurality of pieces of sensor data which are obtained from a plurality of sensors. In addition, when a plurality of pieces of sensor data obtained from a plurality of sensors are used, the sensors maybe a sensor group including sensors of the same type, or may be a sensor group in which different types of sensors are mixed. In the case of integrating and using a plurality of pieces of sensor data, highly accurate deriving of state parameters can be expected over the case of using a single piece of sensor data.

The community-state predictor 65 predicts, by computation, a future state of the crowd based on the state parameter group supplied from the parameter deriving unit 63, and supplies data representing the result of the prediction (hereinafter, also called “predicted-state data”) to each of the security-plan deriving unit 66 and the state-presentation I/F unit 67. The community-state predictor 65 can estimate, by computation, various information that determines a future state of the crowd. For example, the future values of parameters of the same types as state parameters derived by the parameter deriving unit 63 can be calculated as predicted-state data. Note that how far ahead the community-state predictor 65 can predict a future state can be arbitrarily defined according to the system requirements of the security support system 3.

FIG. 16 is a diagram for describing an example of prediction performed by the community-state predictor 65. As shown in FIG. 16, it is assumed that any of the above-described sensors SNR₁ to SNR_{P} is disposed in each of target areas PT1, PT2, and PT3 on pedestrian paths PATH of equal widths. Crowds are moving from the target areas PT1 and PT2 toward the target area PT3. The parameter deriving unit 63 can derive flow rates of the respective crowds in the target areas PT1 and PT2 (unit: the number of individuals times a meter per second) and supply the flow rates as state parameter values to the community-state predictor 65. The community-state predictor 65 can derive, based on the supplied flow rates, a predicted value of a flow rate for the target area PT3 for which the crowds are expected to head. For example, it is assumed that the crowds in the target areas PT1 and PT2 at time T₁ are moving in arrow directions, and a flow rate for each of the target areas PT1 and PT2 is F. At this time, when a crowd behavior model in which the moving speeds of the crowds remain the same from now on, too is assumed and the moving times of the crowds from the target areas PT1 and PT2 to the target area PT3 are both denoted by t, the community-state predictor 65 can predict the value of 2×F as a flow rate for the target area PT3 at the future time of T+t.

Then, the security-plan deriving unit 66 receives a supply of a state parameter group indicating the past and present states of the crowd from the parameter deriving unit 63, and receives a supply of predicted-state data representing the future state of the crowd from the community-state predictor 65. The security-plan deriving unit 66 derives, by computation, a proposed security plan for avoiding congestion and dangerous situations of the crowd, based on the state parameter group and the predicted-state data, and supplies data representing the proposed security plan to the plan-presentation I/F unit 68.

For a method of deriving a proposed security plan by the security-plan deriving unit 66, for example, when the parameter deriving unit 63 and the community-state predictor 65 output a state parameter group and predicted-state data that represent that a given target area is in a dangerous state, a proposed security plan that proposes dispatch of security guards or an increase in the number of security guards to manage staying of a crowd in the target area can be derived. Examples of the “dangerous state” include a state in which “uncontrolled staying” of a crowd or “an individual or group of individuals who engage in dangerous behaviors” is detected, and a state in which a “crowd density” exceeds an allowable value. Here, when a person in charge of security planning can check the past, present, and future states of a crowd on the external device 73, 74 such as a monitor or a mobile communication terminal through the plan-presentation I/F unit 68 which will be described later, the person in charge of security planning can also create a proposed security plan him/herself while checking the states.

The state-presentation I/F unit 67 can generate visual data (e.g., video and text information) or sound data (e.g., audio information) representing the past, present, and future states of the crowd in an easy-to-understand format for users (security guards or a security target crowd), based on the supplied state parameter group and predicted-state data. Then, the state-presentation I/F unit 67 can transmit the visual data and the sound data to the external devices 71 and 72. The external devices 71 and 72 can receive the visual data and the sound data from the state-presentation I/F unit 67, and output them as video, text, and audio to the users. For the external devices 71 and 72, a dedicated monitoring device, a general-purpose PC, an information terminal such as a tablet terminal or a smartphone, or a large display and a speaker that allow an unspecified number of individuals to view can be used.

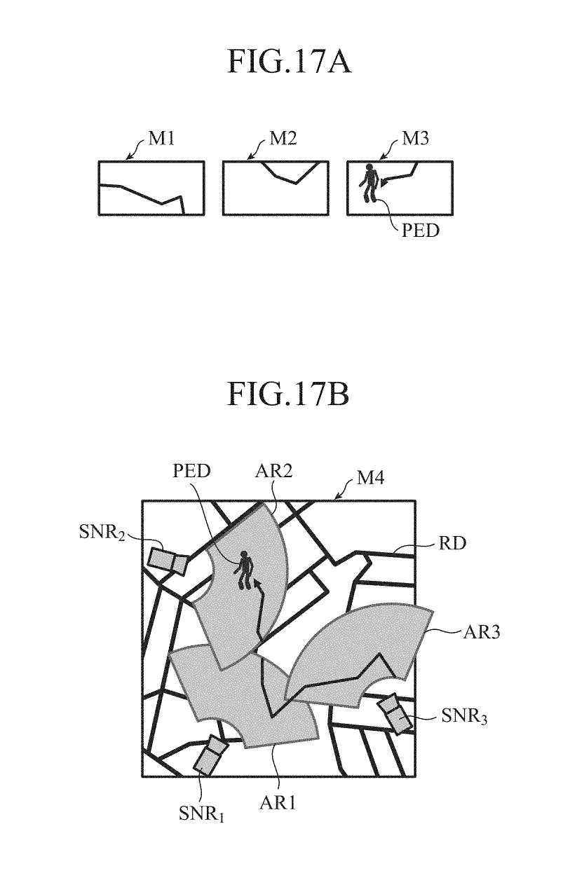

FIGS. 17A and 17B are diagrams showing an example of visual data generated by the state-presentation I/F unit 67. In FIG. 17B, map information M4 indicating sensing ranges is displayed. The map information M4 shows a road network RD; sensors SNR₁, SNR₂, and SNR₃ that sense target areas AR1, AR2, and AR3, respectively; a specific individual PED which is a monitoring target; and a movement track (black line) of the specific individual PED. FIG. 17A shows video information M1 for the target area AR1, video information M2 for the target area AR2, and video information M3 for the target area AR3. As shown in FIG. 17(B), the specific individual PED moves over the target areas AR1, AR2 and AR3. Hence, if a user only sees the video information M1, M2, and M3, then it is difficult to grasp in what route the specific individual PED has moved on the map, unless the user understands the disposition of the sensors SNR₁, SNR₂, and SNR₃. Thus, the state-presentation I/F unit 67 maps states that appear in the video information M1, M2, and M3 onto the map information M4 of FIG. 17B based on the location information of the sensors SNR₁, SNR₂, and SNR₃, and can thereby generate visual data to be presented. By thus mapping the states for the target areas AR1, AR2, and AR3 in a map format, the user can intuitively understand the moving route of the specific individual PED.

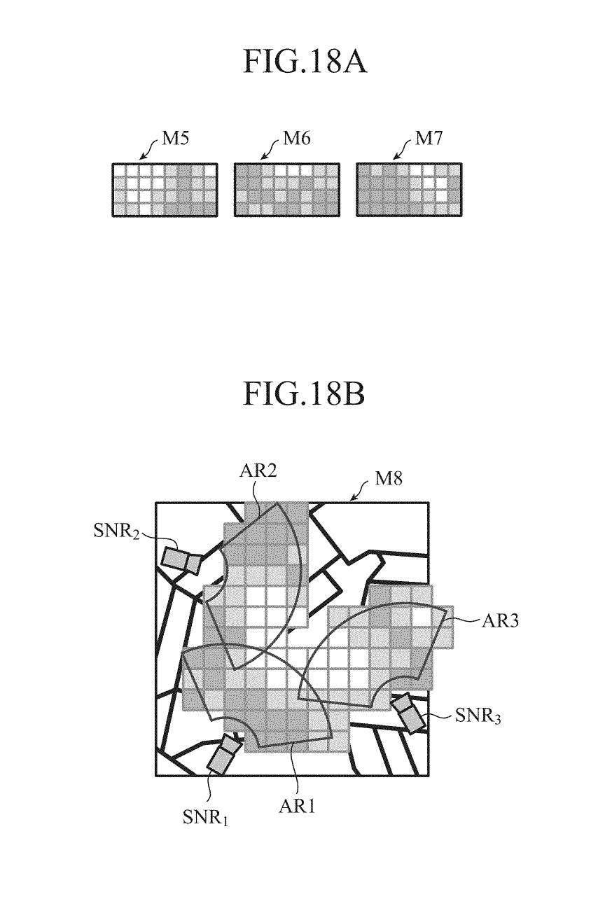

FIGS. 18A and 18B are diagrams showing another example of visual data generated by the state-presentation I/F unit 67. In FIG. 18B, map information M8 indicating sensing ranges is displayed. The map information M8 shows a road network; sensors SNR₁, SNR₂, and SNR₃ that sense target areas AR1, AR2, and AR3, respectively; concentration distribution information indicating the density of a crowd which is a monitoring target. FIG. 18A shows map information M5 indicating crowd density for the target area AR1 in the form of a concentration distribution, map information M6 indicating crowd density for the target area AR2 in the form of a concentration distribution, and map information M7 indicating crowd density for the target area AR3 in the form of a concentration distribution. This example shows that the brighter the color (concentration) in grids in images represented by the map information M5, M6, and M7, the higher the density, and the darker the color the lower the density. In this case, too, the state-presentation I/F unit 67 maps sensing results for the target areas AR1, AR2, and AR3 onto the map information M8 of FIG. 18B based on the location information of the sensors SNR₁, SNR₂, and SNR₃, and can thereby generate visual data to be presented. By this, the user can intuitively understand a crowd density distribution.

In addition to the above, the state-presentation I/F unit 67 can generate visual data representing the temporal transition of the values of state parameters in graph form, visual data notifying about the occurrence of a dangerous state by an icon image, sound data notifying about the occurrence of the dangerous state by an alert sound, and visual data representing public data obtained from the server devices SVR in timeline format.

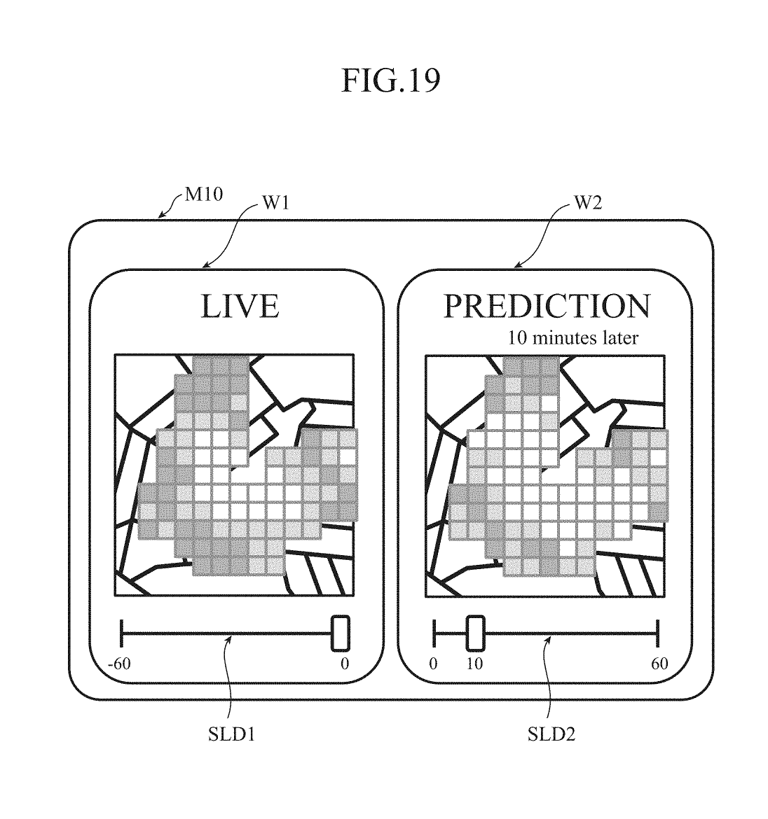

In addition, the state-presentation I/F unit 67 can also generate visual data representing a future state of a crowd, based on predicted-state data supplied from the community-state predictor 65. FIG. 19 is a diagram showing still another example of visual data generated by the state-presentation I/F unit 67 . FIG. 19 shows map information M10 where an image window W1 and an image window W2 are disposed in parallel to each other. Display information on the image window W2 on the right predicts a state that is temporally ahead of display information on the image window W1 on the left.

One image window W1 can display image information that visually indicates a past or present state parameter which is derived by the parameter deriving unit 63. A user can display a present or past state for a specified time on the image window W1 by adjusting the position of a slider SLD1 through a GUI (graphical user interface). In the example of FIG. 19, the specified time is set to zero, and thus, the image window W1 displays a present state in real time and displays the text title “LIVE”. The other image window W2 can display image information that visually indicates future state data which is derived by the community-state predictor 65. The user can display a future state for a specified time on the image window W2 by adjusting the position of a slider SLD2 through a GUI. In the example of FIG. 19, the specified time is set to be 10 minutes later, and thus, the image window W2 shows a state for 10 minutes later and displays the text title “PREDICTION”. The state parameters displayed on the image windows W1 and W2 have the same type and the same display format. By adopting a display mode in this manner, the user can intuitively understand a present state and a scene where the present state is changing.

Note that a single image window may be formed by integrating the image windows W1 and W2, and the state-presentation I/F unit 67 may be configured to generate visual data representing the value of a past, present, or future state parameter within the single image window. In this case, it is desirable to configure the state-presentation I/F unit 67 such that by the user changing a specified time using a slider, the user can check the value of a state parameter for the specified time.

On the other hand, the plan-presentation I/F unit 68 can generate visual data (e.g., video and text information) or sound data (e.g., audio information) representing a proposed security plan which is derived by the security-plan deriving unit 66, in an easy-to-understand format for users (persons in charge of security). Then, the plan-presentation I/F unit 68 can transmit the visual data and the sound data to the external devices 73 and 74. The external devices 73 and 74 can receive the visual data and the sound data from the plan-presentation I/F unit 68, and output them as video, text, and audio to the users. For the external devices 73 and 74, a dedicated monitoring device, a general-purpose PC, an information terminal such as a tablet terminal or a smartphone, or a large display and a speaker can be used.

For a method of presenting a security plan, for example, a method of presenting all users with security plans of the same content, a method of presenting users in a specific target area with a security plan specific to the target area, or a method of presenting individual security plans for each individual can be adopted.

In addition, when a security plan is presented, it is desirable to generate, for example, sound data that allows to actively notify users by sound and vibration of a portable information terminal so that the users can immediately recognize the presentation.

Note that although in the above-described security support system 3, the parameter deriving unit 63, the community-state predictor 65, the security-plan deriving unit 66, the state-presentation I/F unit 67, and the plan-presentation I/F unit 68 are, as shown in FIG. 14, included in the single community monitoring apparatus 60, the configuration is not limited thereto. A security support system may be configured by disposing the parameter deriving unit 63, the community-state predictor 65, the security-plan deriving unit 66, the state-presentation I/F unit 67, and the plan-presentation I/F unit 68 in a plurality of apparatuses in a distributed manner. In this case, these plurality of functional blocks may be connected to each other through an on-premises communication network such as a wired LAN or a wireless LAN, a dedicated network which connects locations, or a wide-area communication network such as the Internet.

In addition, as described above, in the security support system 3, the location information of sensing ranges of the sensors SNR₁ to SNR_{P} is important. For example, it is important to know a location based on which a state parameter such as a flow rate which is inputted to the community-state predictor 65 is obtained. In addition, when the state-presentation I/F unit 67 performs mapping onto a map as shown in FIGS. 18A, 18B and 19, too, the location information of a state parameter is essential.

In addition, a case may be assumed in which the security support system 3 is configured temporarily and in a short period of time according to the holding of a large event. In this case, there is a need to install a large number of sensors SNR₁ to SNR_{P} in a short period of time and obtain location information of sensing ranges. Thus, it is desirable that location information of sensing ranges be easily obtained.

For means for easily obtaining location information of a sensing range, it is possible to use spatial and geographic descriptors according to the first embodiment. In the case of a sensor that can obtain video such as an optical camera or a stereo camera, by using spatial and geographic descriptors, it becomes possible to easily derive which location on a map a sensing result corresponds to. For example, when a relationship between four spatial locations and four geographic locations at minimum that belong to the same virtual plane in video obtained by a given camera is known by the parameter “GNSSInfoDescriptor” shown in FIG. 12, by performing a projective transformation, it is possible to derive which location on a map each location on the virtual plane corresponds to.

The above-described community monitoring apparatus 60 can be configured using, for example, a computer including a CPU such as a PC, a workstation, or a mainframe. When the community monitoring apparatus 60 is configured using a computer, the functions of the community monitoring apparatus 60 can be implemented by a CPU operating according to a monitoring program which is read from a nonvolatile memory such as a ROM. In addition, all or some of the functions of the components 63, 65, and 66 of the community monitoring apparatus 60 may be composed of a semiconductor integrated circuit such as an FPGA or an ASIC, or may be composed of a one-chip microcomputer which is a type of microcomputer.

As described above, the security support system 3 of the third embodiment can easily grasp and predict the states of crowds in a single or plurality of target areas, based on sensor data including descriptor data Dsr which is obtained from the sensors SNR₁, SNR₂, . . . , SNR_{P} disposed in the target areas in a distributed manner and based on public data obtained from the server devices SVR, SVR, SVR on the communication network NW2.

In addition, the security support system 3 of the present embodiment can derive, by computation, information indicating the past, present, and future states of the crowds which are processed in a user understandable format and an appropriate security plan, based on the grasped or predicted states, and can present the information and the security plan to persons in charge of security or the crowds as information useful for security support.

### Fourth Embodiment

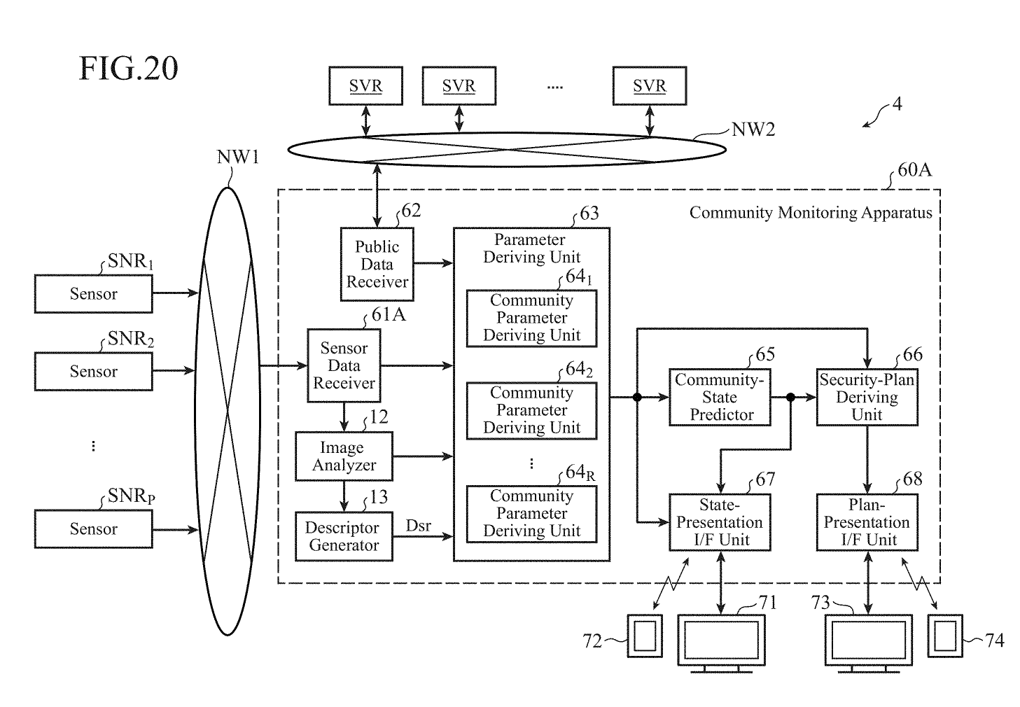

Next, a fourth embodiment according to the present invention will be described. FIG. 20 is a block diagram showing a schematic configuration of a security support system 4 which is an image processing system of the fourth embodiment. The security support system 4 includes P sensors SNR₁, SNR₂, . . . , SNR_{P} (P is an integer greater than or equal to 3); and a community monitoring apparatus 60A that receives, through a communication network NWl, sensor data delivered from each of the sensors SNR₁, SNR₂, . . . , SNR_{P}. In addition, the community monitoring apparatus 60A has the function of receiving public data from each of server devices SVR, . . . , SVR through a communication network NW2.

The community monitoring apparatus 60A of the present embodiment has the same functions and the same configuration as the community monitoring apparatus 60 of the above-described third embodiment, except that the community monitoring apparatus 60A includes some function of a sensor data receiver 61A, an image analyzer 12, and a descriptor generator 13 of FIG. 20.

The sensor data receiver 61A has the same function as the above-described sensor data receiver 61 and has, in addition thereto, the function of extracting, when there is sensor data including a captured image among sensor data received from the sensors SNR₁, SNR₂, . . . , SNR_{P}, the capture image and supplying the captured image to the image analyzer 12.

The functions of the image analyzer 12 and the descriptor generator 13 are the same as those of the image analyzer 12 and the descriptor generator 13 according to the above-described first embodiment. Thus, the descriptor generator 13 can generate spatial descriptors, geographic descriptors, and known MPEG standard descriptors (e.g., visual descriptors representing the quantities of features such as the color, texture, shape, and motion of an object, and a face), and supply descriptor data Dsr representing the descriptors to a parameter deriving unit 63. Therefore, the parameter deriving unit 63 can generate state parameters based on the descriptor data Dsr generated by the descriptor generator 13.

Although various embodiments according to the present invention are described above with reference to the drawings, the embodiments are exemplification of the present invention and thus various embodiments other than these embodiments can also be adopted. Note that free combinations of the above-described first, second, third, and fourth embodiments, modifications to any component in the embodiments, or omissions of any component in the embodiments, within the spirit and scope of the present invention, may be made.

### INDUSTRIAL APPLICABILITY

An image processing apparatus, image processing system, and image processing method according to the present invention are suitable for use in, for example, object recognition systems (including monitoring systems), three-dimensional map creation systems, and image retrieval systems.

### REFERENCE SIGNS LIST

1, 2: Image processing system; 3, 4: Security support system; 10: Image processing apparatus; 11: receiver; 12: Image analyzer; 13: Descriptor generator; 14: Data-storage controller; 15: Storage; 16: DB interface unit; 18: Data transmitter; 21: decoder; 22: Image recognizer; 22A: Object detector; 22B: Scale estimator; 22C: Pattern detector; 22D: Pattern analyzer; 23: Pattern storage unit; 31 to 34: Object; 40: Display device; 41: Display screen; 50: Image storage apparatus; 51: Receiver; 52: Data-storage controller; 53: Storage; 54: DB interface unit; 60, 60A: Community monitoring apparatuses; 61, 61A: Sensor data receivers; 62: Public data receiver; 63: Parameter deriving unit; 64₁ to 64_{R}: Community parameter deriving units; 65: Community-state predictor; 66: security-plan deriving unit; 67: State presentation interface unit (state-presentation I/F unit); 68: Plan presentation interface unit (plan-presentation I/F unit); 71 to 74: External devices; NW, NW1, NW2: Communication networks; NC₁ to NC_{N}: Network cameras; Cm: Imaging unit; Tx: Transmitter; and TC₁ to TC_{M}: Image-transmitting apparatuses.

1. An image processing apparatus comprising:
an image analyzer to analyze an input image thereby to detect one or more objects appearing in the input image, and estimate quantities of one or more spatial features of the detected one or more objects with reference to real space; and
a descriptor generator to generate one or more spatial descriptors representing the estimated quantities of one or more spatial features, each spatial descriptor having a format to be used as a search target, wherein,
the image analyzer, when detecting an object disposed in a position with respect to a ground and having a known physical dimension from the input image, detects a plane on which the detected object is disposed, and estimates a quantity of a spatial feature of the detected plane.

2. The image processing apparatus according to claim 1, wherein the quantities of one or more spatial features are quantities indicating physical dimensions in real space.

3. The image processing apparatus according to claim 1, further comprising a receiver to receive transmission data including the input image from at least one imaging camera.

4. The image processing apparatus according to claim 1, further comprising a data-storage controller to store data of the input image in a first data storing unit, and to associate data of the one or more spatial descriptors with the data of the input image and store the data of the one or more spatial descriptors in a second data storing unit.

5. The image processing apparatus according to claim 4, wherein:
the input image is a moving image; and
the data-storage controller associates the data of the one or more spatial descriptors with one or more images displaying the detected one or more objects among a series of images forming the moving image.

6. The image processing apparatus according to claim 1, wherein:
the image analyzer estimates geographic information of the detected one or more objects; and
the descriptor generator generates one or more geographic descriptors representing the estimated geographic information.

7. The image processing apparatus according to claim 6, wherein the geographic information is positioning information indicating locations of the detected one or more objects on the Earth.

8. The image processing apparatus according to claim 7, wherein the image analyzer detects a code pattern appearing in the input image and analyzes the detected code pattern to obtain the positioning information.

9. The image processing apparatus according to claim 6, further comprising a data-storage controller to store data of the input image in a first data storing unit, and to associate data of the one or more spatial descriptors and data of the one or more geographic descriptors with the data of the input image, and store the data of the one or more spatial descriptors and the data of the one or more geographic descriptors in a second data storing unit.

10. The image processing apparatus according to claim 1, further comprising a data transmitter to transmit the one or more spatial descriptors.

11. The image processing apparatus according to claim 10, wherein:
the image analyzer estimates geographic information of the detected one or more objects;
the descriptor generator generates one or more geographic descriptors representing the estimated geographic information; and
the data transmitter transmits the one or more geographic descriptors.

12. An image processing system comprising:
a receiver to receive one or more spatial descriptors transmitted from an image processing apparatus according to claim 10;
a parameter deriving unit to derive a state parameter indicating a quantity of a state feature of an object group, based on the one or more spatial descriptors, the object group being a group of the detected objects; and
a state predictor to predict a future state of the object group based on the derived state parameter.

13. An image processing system comprising:
an image processing apparatus according to claim 1;
a parameter deriving unit to derive a state parameter indicating a quantity of a state feature of an object group, based on the one or more spatial descriptors, the object group being a group of the detected objects; and
a state predictor to predict, by computation, a future state of the object group based on the derived state parameter.

14. The image processing system according to claim 13, wherein:
an image analyzer estimates geographic information of the detected objects;
a descriptor generator generates one or more geographic descriptors representing the estimated geographic information; and
the parameter deriving unit derives the state parameter indicating the quantity of the state feature, based on the one or more spatial descriptors and the one or more geographic descriptors.

15. The image processing system according to claim 12, further comprising a state presentation interface unit to transmit data representing the state predicted by the state predictor to an external device.

16. The image processing system according to claim 13, further comprising a state presentation interface unit to transmit data representing the state predicted by the state predictor to an external device.

17. The image processing system according to claim 15, further comprising:
a security-plan deriving unit to derive, by computation, a proposed security plan based on the state predicted by the state predictor; and
a plan presentation interface unit to transmit data representing the derived proposed security plan to an external device.

18. The image processing system according to claim 16, further comprising:
a security-plan deriving unit to derive, by computation, a proposed security plan based on the state predicted by the state predictor; and
a plan presentation interface unit t transmit data representing the derived proposed security plan to an external device.

19. An image processing method comprising:
analyzing an input image thereby to detect one or more objects appearing in the input image;
estimating quantities of one or more spatial features of the detected one or more objects with reference to real space;
when the detected object is disposed in a position with respect to a ground and has a known physical dimension, detecting a plane on which the detected object is disposed, and estimating a quantity of a spatial feature of the detected plane; and
generating one or more spatial descriptors representing the estimated quantities of one or more spatial features, each spatial descriptor having a format to be used as a search target.

20. The image processing method according to claim 19, further comprising:
mating geographic information of the one or more detected objects; and
generating one or more geographic descriptors representing the estimated geographic information.
